(19) United States
(12) Patent Application Publication
(10) Pub. No.: US 2009/0177517 A1
(43) Pub. Date: Jul. 9, 2009

(54) System and method for tracking a contract

(75) Inventors: Scott David Nichols, Pekin, IL (US); Scott Dale Watson, Pekin, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/007,213

(22) Filed: Jan. 8, 2008

(51) Int. Cl. G06Q 10/00; G06F 3/00

(52) U.S. Cl. 705/9; 705/7; 715/700

(57) ABSTRACT

A system for tracking a contract is disclosed. The system may include a user input interface configured to receive a user request to track a contract from a contract administrator, a storage device configured to store contract-related information, and a processor. The processor may be configured to determine a list of approvers who need to approve the contract based on a financial impact of the contract and determine a signature approver who needs to sign the contract from the list of approvers. The processor may be further configured to generate an approval and signature request and send the approval and signature request to each approver on the list of approvers, and notify employees of one or more departments when the contract is signed.

### TECHNICAL FIELD

The present disclosure relates generally to a system and method for conducting business, and relates more particularly to a system and method for tracking a contract.

### BACKGROUND

A business organization is typically divided into departments, where each department includes a group of employees and specializes in performing a specific task. Generally, large business organizations include a greater number of departments than small business organizations, and within each of those departments, large business organizations may include a greater number of employees. Documents usually move between different departments and employees, and due to the size and number of departments and employees, tracking the documents manually proves difficult. As a result, the documents can move slowly, and important deadlines can be missed. This lack of document tracking can also result in mistakes and other inefficiencies that could limit the business organization's performance.

A system developed to assist in the tracking of documents is disclosed in U.S. Patent Publication No. 2005/0160278 to Farquharson et al. (“the '278 publication”). In particular, the '278 publication discloses an automated contract approval system and method. The contract approval system generates and sends an electronic approval notification to a person for approving the contract. The electronic approval notification may include a link to a webpage where the person can approve the contract electronically. After the contract is approved and executed by the designated person(s), it may be marked as “Signed” by the contract approval system.

Although the system of the '278 publication may alleviate some of the problems, it may still be suboptimal. That is, because the person who receives the electronic approval notification may not review and approve the contract right away, the process may still suffer delays. In addition, there may be situations when employees in several departments must be notified that the contract is signed, and the '278 publication does not account for these situations.

The system and method of the present disclosure is directed towards overcoming one or more of the constraints set forth above.

### SUMMARY

In one aspect, the present disclosure is directed to a system for tracking a contract. The system may include a user input interface configured to receive a user request to track a contract from a contract administrator, a storage device configured to store contract-related information, and a processor. The processor may be configured to determine a list of approvers who need to approve the contract based on a financial impact of the contract and determine a signature approver who needs to sign the contract from the list of approvers. The processor may be further configured to generate an approval and signature request and send the approval and signature request to each approver on the list of approvers, and notify employees of one or more departments when the contract is signed.

In another aspect, the present disclosure is directed to a method for tracking a contract. The method may include receiving a user request of tracking a contract from a contract administrator, and determining a list of approvers who need to approve the contract based on a financial impact of the contract and determine a signature approver who needs to sign the contract from the list of approvers. The method may further include generating an approval and signature request and sending the approval and signature request to each approver on the list of approvers, and notifying employees of one or more departments when the contract is signed.

### BRIEF DESCRIPTION OF THE DRAWINGS

FIG. 1 is a schematic diagram of a network for tracking a contract according to an exemplary embodiment of the present disclosure;

FIG. 2 is a schematic diagram of a server system according to an exemplary disclosed embodiment of the present disclosure;

FIG. 3 is an illustration of a contract tracking request view according to an exemplary embodiment of the present disclosure; and

FIG. 4 is a flow chart of an exemplary operation process for tracking a contract, consistent with the disclosed embodiment shown in FIG. 1.

### DETAILED DESCRIPTION

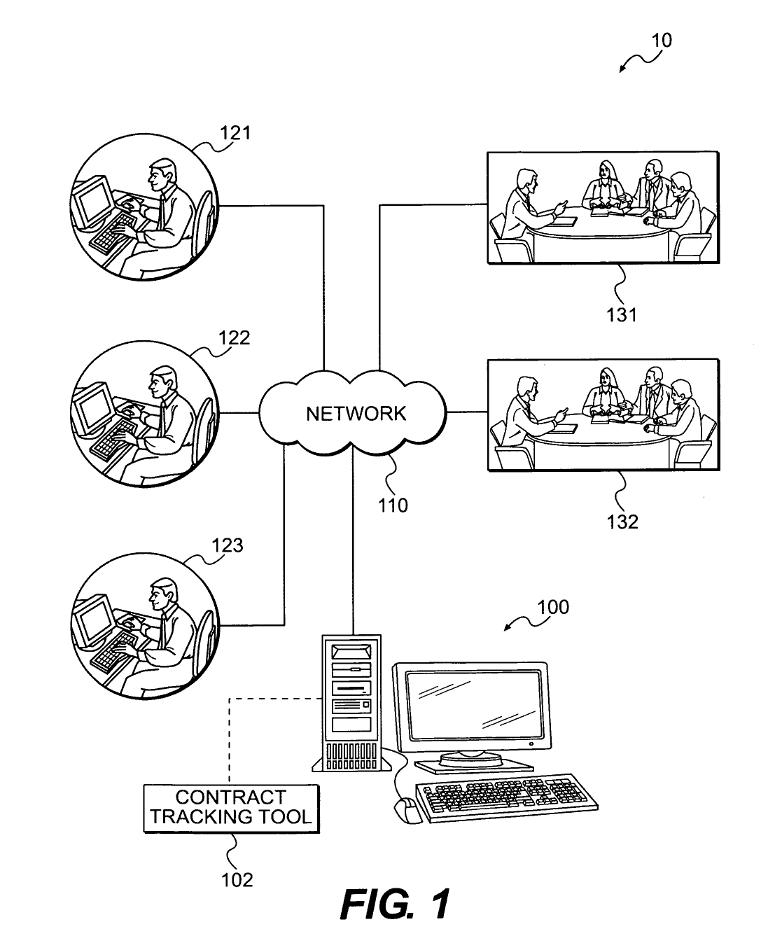

FIG. 1 is a schematic diagram of a network for tracking a contract according to an exemplary embodiment of the present disclosure. A business organization 10 may include one or more departments, each specializing in one or more business areas of business organization 10. For example, as shown in FIG. 1, business organization 10 may include a contract drafting and negotiation department 131, and a payment department 132. Business organization 10 may also include other departments, such as a record department (not shown) and a legal department (not shown). Contract drafting and negotiation department 131 may prepare and negotiate a contract with an external party. For example, contract drafting and negotiation department 131 may negotiate a carrier contract with a third party freight carrier. The carrier contract may specify a new rate of shipping goods for business organization 10.

Business organization 10 may further include a list of people who are authorized to approve and/or sign contracts negotiated by contract drafting and negotiation department 131. The list of people may include managers of different levels. The contract may be approved in the order of management level, for example, by a first approver 121, and then by a second approver 122. The contract may be approved and signed by the highest level manager on the list, for example, a signature approver 123.

To track the approval. and signature process, business organization 10 may include a server system 100. Server system 100 may include one or more computer assemblies configured to run a contract tracking tool program. Server system 100 may be owned and/or operated by business organization 10 and, as such, access to its contents may be limited to certain departments, such as, contract drafting and negotiation department 131 and payment department 132. Furthermore, within the authorized department(s), different personnel may have different levels of access depending on the type of information or content they are authorized to view. Access may be regulated using any suitable password application known in the art. Data transferred to and from server system 100 may be protected using encryption software and other protection schemes, as would be apparent to one skilled in the art.

Server system 100 may include one or more software applications, including, for example, a contract tracking tool 102. Contract tracking tool 102 may run on server system 100, and may be accessed by authorized departments 131 and 132 via their respective systems and a network 110, such as, for example, the Internet. It is also contemplated that the contract tracking tool program may be stored on a computer readable medium, such as a hard drive, computer disk, CD-ROM, or any other suitable medium, and may run on systems of the one or more departments and by one or more approvers within business organization 10.

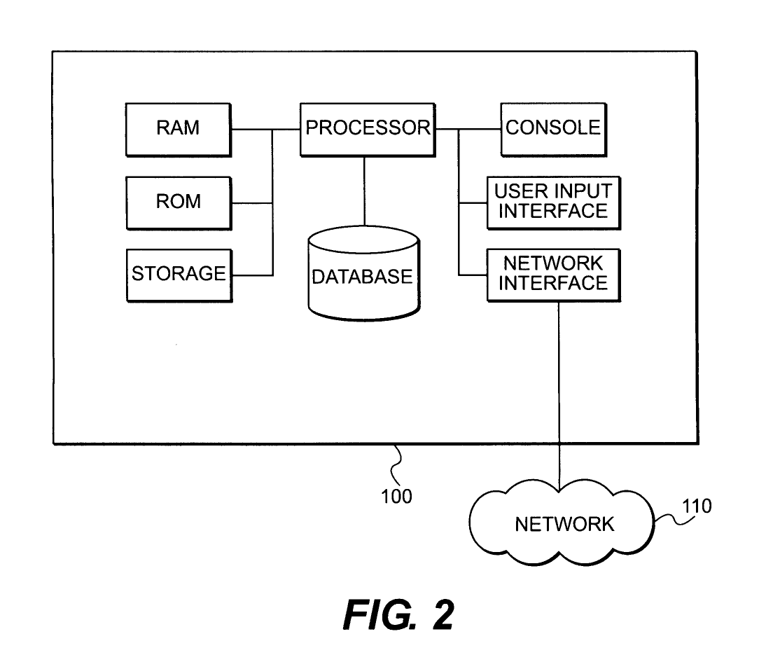

FIG. 2 is a schematic diagram of server system 100 according to an exemplary disclosed embodiment of the present disclosure. As shown in FIG. 2, server system 100 may include a random access memory (“RAM”) 210, a read only memory (“ROM”) 220, a storage device 230, a processor 240, a database 250, a console 260, a user input device 270, and a network interface 280. It is contemplated that server system 100 may include additional, fewer, and/or different components than those listed above. It is understood that the type and number of listed devices are exemplary only and not intended to be limiting.

Processor 240 may be a central processing unit (“CPU”). Processor 240 may execute sequences of computer program instructions to perform various processes that will be explained later. The computer program instructions may be accessed and read from ROM 220, or any other suitable memory location, and loaded into RAM 210 for execution by processor 240. Depending on the type of server system 100 being used, processor 240 may include one or more printed circuit boards, and/or a microprocessor chip.

Server system 100 may be accessed and controlled by a contract administrator, such as an employee of contract drafting and negotiation department 132, using console 260 and user input interface 270. Console 260 may provide a graphical user interface (“GUI”) to provide information to the contract administrators who use server system 100. Additionally, console 260 may include an appropriate computer display device including, for example, a computer screen (not shown). User input interface 270 may be provided for the contract administrators to input information into server system 100, and may include, for example, a keyboard, a mouse, and/or optical or wireless computer input devices (not shown). Network interface 280 may provide communication connections such that server system 100 may be accessible remotely through computer networks.

Storage device 230 may include any type of mass storage suitable for storing information. For example, storage device 230 may include one or more hard disk devices, optical disk devices, or any other storage devices that provide data storage space. In one embodiment of the present disclosure, database 250 may store data related to contract approval and signature process, as well as copies of contracts. Database 250 may also include analysis and organization tools for analyzing and organizing the information contained therein.

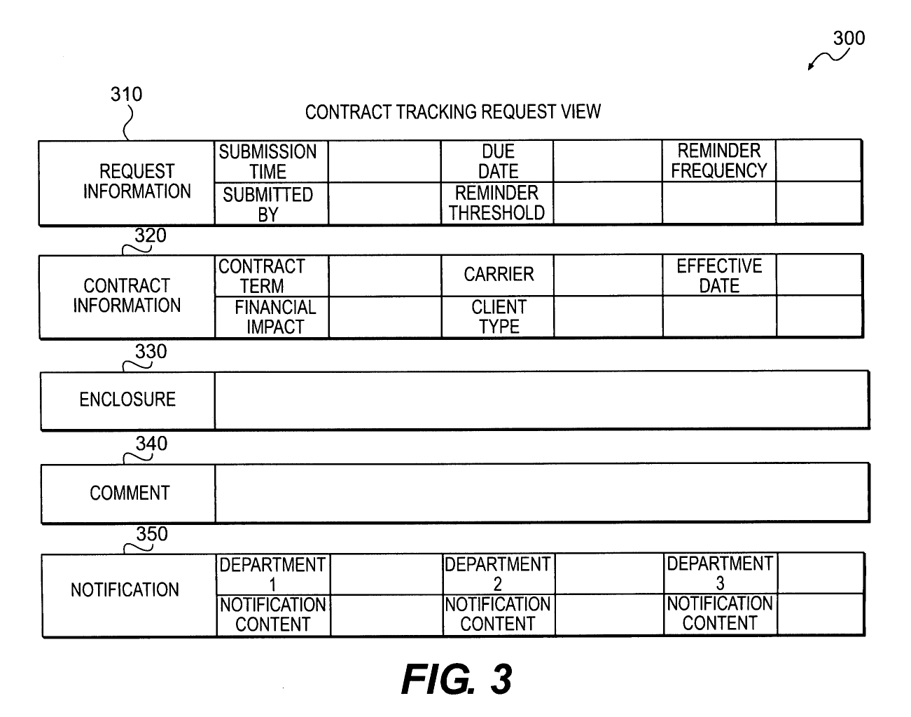

Contract tracking tool 102 may include one or more sections, in the form of charts, tables, spreadsheets, web pages, templates or any other similar organizational structures, for conveying data to a contract administrator and receiving data from the contract administrator. For example, contract tracking tool 102 may include at least one contract tracking request view 300, depicted in FIG. 3 as it might appear on console 260. Contract tracking request view 300 may include one or more fields for receiving and displaying data. Contract tracking request view 300 may include a variety of possible alternatives and they may be grouped in one or more general categories. For example, contract tracking request view 300 may include a request information field 310, a contract information field 320, an enclosure field 330, a comment field 340, and a notification field 350. It should be understood that contract tracking request view 300 may include fewer, more, or different general categories based on the characteristics and needs of business organization 10.

Authorized employees may access contract tracking tool 102 and input information in contract tracking request view 300 via user input interface 270 or via input devices associated with their department systems. Administrators of server system 100 may change or update the category fields of contract tracking request view 300 to adapt contract tracking tool 102 for use with new customers or in new areas of business.

Request information field 310 may include items such as a submission time, the name of a person who submitted the request, and a contract signature due date. The submission time may also be filled in automatically by contract tracking tool 102 when a new contract tracking request view 300 is initiated. The contract signature due date may be the contract effective date by default. The contract administrator who uses contract tracking tool 102 may also specify a different date prior to the contract effective date. Depending on the urgency of the contract, the contract administrator may specify a reminder threshold which is a threshold value typically in days. If an approver does not take any action for a period greater than the reminder threshold, reminders may be continuously sent to the approver. Additionally, the reminders may also been sent to the person(s) working closely with the approver so that they may manually remind the approver. For example, the reminders may also be sent to the approver's supervisor or secretary. The reminders may also be sent to the contract administrator who requested the tracking so that he/she may have a timely update of the contract status. The contract administrator may also input a reminder frequency to specify how frequently the reminders may be sent to the approver. For example, reminders may be sent every day or every three days, depending on the urgency of the contract.

The contract administrator may also leave the reminder threshold and the reminder frequency blank, and let the system determine the values based on the contract signature due date. In this case, contract tracking tool 102 may first calculate the number of days (Nd) left before the contract signature is due, and also determine the number of approvers (Na) left on the list to approve the contract. Contract tracking tool 102 may then divide Nd by Na, and use the quotient as the reminder threshold, or alternatively, offset the quotient by an integer number and use the resulted value as the reminder threshold. For example, if there are 15 days left before the contract signature is due, and there are 3 more approvers left on the list to approve the contract, the system may determine a reminder threshold of 3 days as 15 divided by 3 and then offset by 2. In determine the reminder frequency, the system may use a lookup table that maps each reminder threshold to an integer number, and use that integer number as the reminder frequency. For example, a reminder threshold of 10 days may correspond to a two-day reminder frequency, and a reminder threshold of 5 days may correspond to a one-day reminder frequency.

Contract information field 320 may include items such as a contract term, a financial impact, a carrier, a client type and an effective date. A contract administrator of contract tracking tool 102 may specify contract terms manually or select the contract terms from an available term list. The financial impact may represent a monetary value of the contract. For example, in a carrier contract, the financial impact may be affected by a rate of each shipment and a number of the shipments. Depending on the financial impact, the list of people who need to approve the contract may vary. A contract having a higher financial impact may require approval and signature by higher level administrators. For example, if a contract has a financial impact of $10,000, a project manager may be required to approve it and a department head may be required to sign it. If a contract has a financial impact of $100,000, the project manager and department head may be required to approve it, and the vice president of business organization 10 may be required to sign it.

A contract administrator who uses contract tracking tool 102 may select a carrier from a list of carriers, or add a new carrier. The client type may include an internal client, for example, a certain department of business organization 10, or an external client. The contract effective date may be the date on which the contract becomes effective. For example, a new rate recited in a carrier contract may be effective beginning Jan. 1, 2007. The contract effective date may be used to determine the contract signature due date, the reminder threshold, and the reminder frequency in request information field 310. For example, if there are 15 days left before the contract effective date, and there are still 3 approvers left on the list to approve the contract, contract tracking tool 102 may automatically determine a three-day reminder threshold and a one-day reminder frequency.

Enclosure field 330 may allow the contract administrator to attach a copy of the negotiated contract, or any other relevant documents the contract administrator wishes to bring to the attention of the approvers. Enclosure field 330 may accept documents in a variety of formats including, but not limited to, .doc, .txt, .rtf, .pdf, ps documents. Comment field 340 may allow the contract administrator to input any additional comments or suggestions he/she would like to submit to the approvers. For example, the contract administrator may specify the sections of the contract to which he/she wants the approvers to pay special attention.

Notification field 350 may include input items for one or more departments (department 1, department 2, and department 3, as shown in FIG. 3), employees of which are to be notified after the contract is approved and signed, and the notification content to be included in the notification to employees of each department. The contract administrator may select the department(s) from a list of departments, or manually specify the department(s). For example, the contract administrator may specify department 1 as payment department 132, and the notification content may include the new shipping rate and the rate effective date.

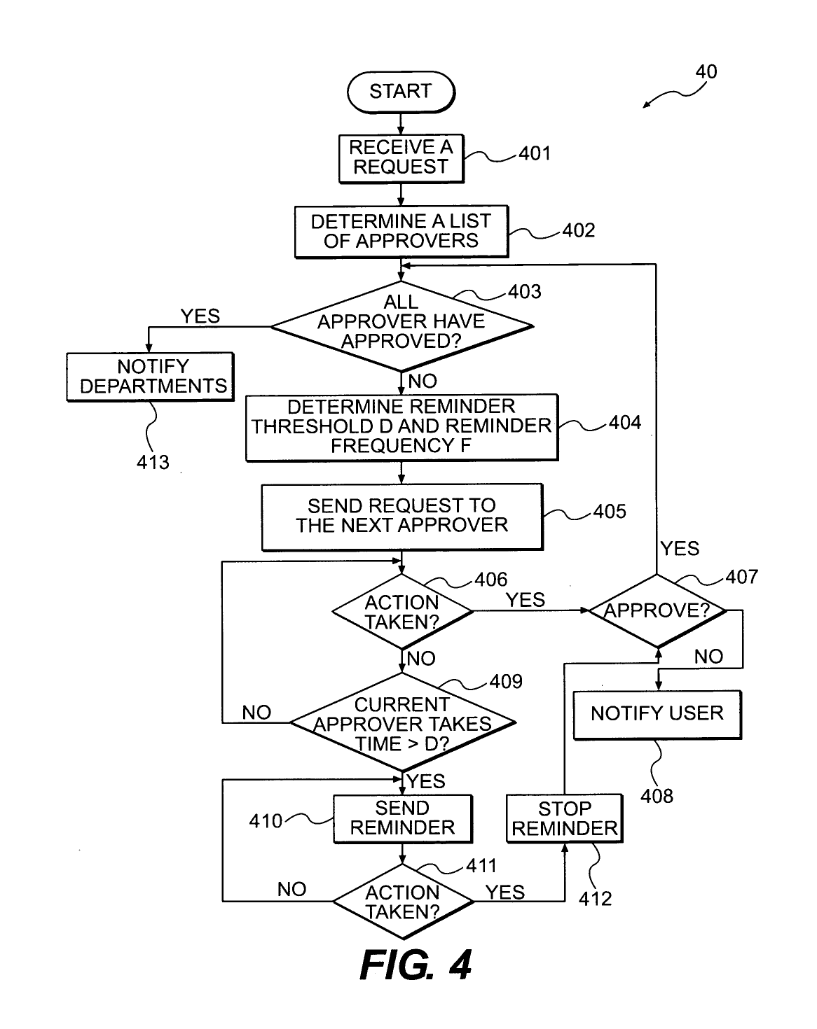

FIG. 4 is a flow chart of an exemplary operation process 40 for tracking a contract, consistent with the disclosed embodiment shown in FIG. 1. Process 40 may begin when a contract administrator request to track a contract is received from contract drafting and negotiation department 131, along with a copy of the negotiated contract as an enclosure to enclosure field 330 (Step 401). Based on a financial impact of the contract, contract tracking tool 102 may operate to determine a list of approvers who are required to approve the contract in business organization 10 (Step 402). For example, as shown in FIG. 1, for a given financial impact (e.g., $100,000), first approver 121, second approver 122 and signature approver 123 may be required to approve the contract, and signature approver 123 may further be required to sign the contract before the contract may be effective.

After the list of approvers is determined, contract tracking tool 102 may start an approval and signature tracking process. Contract tracking tool 102 may determine whether all the approvers have approved the contract (Step 403). If at least one approver has not approved the contract (Step 403: No), contract tracking tool 102 may determine a reminder threshold value D and a reminder frequency F based on the current date, the contract signature due date, and the remaining number of approvers using the algorithm described earlier in this application. Alternatively, contract tracking tool 102 may also determine D and F based on the user-input reminder threshold and reminder frequency in tracking request field 310 (Step 404). The reminder threshold value D, when determined by contract tracking tool 102 in an automated manner, may dynamically vary during the tracking process. For example, a reminder frequency F=2 may be used when the system sends out the first few reminders, but it may be changed to F=1 later on when a few more days have elapsed and the approver still has not taken at action.

As shown in FIG. 4, contract tracking tool 102 may then generate an approval and/or signature request and send the request to the next approver on the list (Step 405). An approval request may be sent to lower level approvers, such as first approver 121 and second approver 122. An approval and signature request may be sent to the highest level approver, such as signature approver 123. Each request may be an email sent to the inbox of the approver. The request may include a list of contract information and the negotiated contract as an attachment. The approver may send an electronic approval by email. Alternatively, a link of a webpage where the approver may review the contract may be included in the request. The approver may approve the contract electronically on the webpage. The signature approver may print out the contract and sign the contract manually or, alternatively, sign the contract electronically if both parties of the contract accept electronic signatures.

After each request is sent, contract tracking tool 102 may continuously monitor the status and determine whether any actions have been taken by the current approver (Step 406). Actions may include approval and decline of the contract. If an action is taken (Step 406: Yes), contract tracking tool 102 may determine whether it is an approval action (Step 407). If the action is an approval action (Step 407: Yes), contract tracking tool 102 may return to Step 403 and proceed with the next approver on the list (if there is any remaining approvers on the list). If the action is a decline action (Step 407: No), the approver may be requested to provide feedback explaining the reason of decline, and contract tracking tool 102 may notify the contract administrator and send the approver's feedback to the contract administrator (Step 408).

If an action is not taken (Step 406: No), contract tracking tool 102 may compare the elapsed time with the reminder threshold value D (Step 409). If the elapsed time is less than threshold D (Step 409: No), contract tracking tool 102 may return to Step 406 and continue monitoring the status. However, if the elapsed time is greater than threshold D (Step 409: Yes), contract tracking tool 102 may generate and send reminders to the current approver at the reminder frequency F.(Step 410). The reminder may include a copy of the initial approval and/or signature request sent in Step 405, and an action due date. Along with the reminders, contract tracking tool 102 may continuously monitor the status and determine whether any actions have been taken by the current approver (Step 411). If an action is taken (Step 411: Yes), contract tracking tool 102 may stop sending reminders to the current approver (Step 412), and return to Step 407 to determine whether the action is an approval action or a decline action.

Contract tracking tool 102 may repeat Steps 403-412 until all the approvers approve the contract. Once all the approvers have approved the contract (Step 403: Yes), contract tracking tool 102 may notify employees of one or more related departments (Step 413). For example, employees of payment department 132 may be notified when a carrier contract specifying a new carrier rate is signed, and payment department 132 may adjust the rate to be in effect on the contract effective date. In another example, employees of the legal department and the record department may also be notified, so that they may incorporate a copy of the contract in their respective databases.

It is contemplated that multiple contract administrators may access and use contract tracking tool 102 simultaneously over network 110. Each contract administrator may be responsible for entering data for one or more contract tracking request views 300. Thus, contract tracking tool 102 may serve as an electronic documentation tracking tool between an entire network of departments and managers, within business organization 10, while also acting as a watch-dog tool that may help ensure the contract is signed before the effective date.

### INDUSTRIAL APPLICABILITY

The disclosed system and method may have applicability in a business organization 10 that involves a contract approval and signature process. The system may include a contract tracking tool 102. Contract tracking tool 102 may receive a user input, organize and monitor the contract approval and signature process, and notify employees of several departments of business organization 10 after the contract is signed.

For example, contract drafting and negotiation department 131 may negotiate a carrier contract with a freight service provider. The carrier contract may specify a new shipping rate. An employee of contract drafting and negotiation department 131 may use contract tracking tool 102 to initiate a contract tracking process, by inputting at a contract tracking request view 300. Upon receiving the tracking request, contract tracking tool 102 may determine a list of approvers who need to approve and sign the contract, based on a financial impact of the carrier contract. Generally, in business organization 10, a group of managers, such as approvers 121, 122 and 123, may be authorized to approve and/or sign the contract before it becomes effective. Contract tracking tool 102 may send electronic approval requests to these approvers in order, typically from the lowest level manager to the highest level manager. The highest level manager, i.e., the signature approver 123, may sign the contract after everyone on the approver list approves.

Contract tracking tool 102 may also determine a reminder threshold and reminder frequency based on the current date and the contract signature due date. If a particular approver, for example, first approver 121, does not take action for a time period longer than the reminder threshold, contract tracking tool 102 may send electronic reminders to first approver 121 at the determined reminder frequency (e.g., once a day) until an action is taken. First approver 121 may electronically approve or decline the contract. In case the contract is declined, first approver 121 may be required to provide feedback explaining the reason(s) of decline. The contract administrator who initiated the tracking process may be notified and provided with the approver's feedback for decline.

Once approvers 121-123 approve the contract and signature approver 123 signs the contract, contract tracking tool 102 may notify employees of one or more related departments of business organization 10. For example, employees of payment department 132 may be notified for the new shipping rate and the effective date of the rate. Accordingly, payment department 132 may adjust the payment based on the new rate after its effective date. Employees of the legal and record departments may also be notified that the contract has been signed and a copy of the contract may be sent to these departments for their records.

Although the disclosed embodiments are described in association with a contract tracking process, the disclosed tracking tool and tracking method may be used in any document tracking process. The disclosed tracking tool may efficiently and effectively manage the document flow, and ensure that deadlines for approval are met. For example, delays may be minimal because the disclosed tracking tool may send reminders to the document user if the user has the document for an elapsed time longer than a threshold. Furthermore, the disclosed tracking tool may enhance the efficiency of business organization 10 because it may notify employees of one ore more relevant departments about the status of a document, and thus may enable these employees to take quick actions accordingly.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A system for tracking a contract, comprising:
a user input interface configured to receive a request to track a contract from a contract administrator;
a storage device configured to store contract-related information; and
a processor configured to:
determine a list of approvers who need to approve the contract based on a financial impact of the contract and determine a signature approver who needs to sign the contract from the list of approvers;
generate an approval and signature request and send the approval and signature request to each approver on the list of approvers; and
notify employees of one or more departments when the contract is signed.

2. The system of claim 1, wherein the user input interface displays a contract tracking request view that includes:
a tracking request field for inputting tracking request information;
a contract information field for inputting negotiated contract terms and the financial impact; and
an enclosure field for attaching a copy of a negotiated contract.

3. The system of claim 2, wherein the contract tracking request view further includes a comment field for providing comments or suggestions to the approvers.

4. The system of claim 2, wherein the contract tracking request view further includes a notification field for inputting names of departments the employees of which are to be notified when the contract is signed.

5. The system of claim 1, wherein the contract-related information includes a negotiated contract, names of people authorized to approve contracts, and names of departments the employees of which are to be notified when the contract is signed.

6. The system of claim 1, wherein the approval and signature request is sent to each approver from the list of approvers in an order of a management level, and the signature approver receives the approval and signature request last.

7. The system of claim 1, wherein the processor is further configured to send a reminder to an approver from the list of approvers if an action is not taken by the approver after a threshold period.

8. The system of claim 1, wherein the processor is further configured to notify the contract administrator if any approver from the list of approvers declines the contract and send comments of the declining approver to the contract administrator.

9. The system of claim 1, wherein the processor is further configured to selectively restrict access to the system for tracking the contract.

10. A method for tracking a contract, the method comprising:
receiving a request to track a contract from a contract administrator;
determining a list of approvers who need to approve the contract based on a financial impact of the contract and determine a signature approver who needs to sign the contract from the list of approvers;
generating an approval and signature request and sending the approval and signature request to each approver on the list of approvers; and
notifying employees of one or more departments when the contract is signed.

11. The method of claim 10, wherein the request includes tracking request information, negotiated contract terms, the financial impact, and a copy of a negotiated contract that requires approval and signature.

12. The method of claim 11, wherein the request further includes comments or suggestions to the approvers.

13. The method of claim 11, wherein the request further includes names of departments the employees of which are to be notified when the contract is signed.

14. The method of claim 10, further including storing a negotiated contract, names of people authorized to approve contracts, and names of departments the employees of which are to be notified when the contract is signed.

15. The method of claim 10, wherein sending the requests to each approver on the list of approvers includes sending the requests by email.

16. The method of claim 10, further including sending the reminder to an approver from the list of approvers if an action is not taken by the approver within a threshold period of time.

17. The method of claim 16, wherein sending the reminder to the approver from the list of approvers includes sending the reminder at a user-defined frequency.

18. The method of claim 16, wherein the threshold period is determined automatically based on a contract effective date.

19. The method of claim 10, further including:
notifying the contract administrator if any approver from the list of approvers declines the contract; and
sending comments of the declining approver to the contract administrator.

20. A computer readable medium having stored thereon instructions for tracking a contract, including:
receiving a request to track a contract from a contract administrator;
determining a list of approvers who need to approve the contract based on a financial impact of the contract and determine a signature approver who needs to sign the contract from the list of approvers;
generating an approval and signature request and sending the approval and signature request to each approver on the list of approvers; and
notifying employees of one or more departments when the contract is signed.
